(19) United States
(12) Patent Application Publication
(10) Pub. No.: US 2013/0166186 A1
(43) Pub. Date: Jun. 27, 2013

(54) Method and Device For Operating A Cold Start Emission Control Of An Internal Combustion Engine

(71) Applicants: Guido Porten, Vaihingen/Enz (DE); Uwe Mueller, Cleebronn (DE); Alexandra Fuchsbauer, Stuttgart (DE)

(72) Inventors: Guido Porten, Vaihingen/Enz (DE); Uwe Mueller, Cleebronn (DE); Alexandra Fuchsbauer, Stuttgart (DE)

(21) Appl. No.: 13/713,333

(22) Filed: Dec. 13, 2012

(30) Foreign Application Priority Data
Dec. 21, 2011 (DE) 10 2011 089 370.9

(51) Int. Cl. F02D 45/00

(52) U.S. Cl. CPC F02D 45/00
USPC 701/113

(57) ABSTRACT

A method for operating a cold start emission control of an internal combustion engine, a combustion chamber pressure in at least one cylinder of the internal combustion engine being initially detected, at least one characteristic variable for a combustion process of the internal combustion engine being determined based on the detected combustion chamber pressure, a setpoint value being established for the characteristic variable, a deviation of the characteristic variable from the setpoint value being determined, and an error entry being generated as a function of the determined deviation.

### RELATED APPLICATION INFORMATION

The present application claims priority to and the benefit of German patent application no. 10 2011 089 370.9, which was filed in Germany on Dec. 21, 2011, the disclosure of which is incorporated herein by reference.

### FIELD OF THE INVENTION

The present invention relates to a method for operating a cold start emission control of an internal combustion engine, in particular for evaluating a functionality of a cold start emission control. Furthermore, the present invention relates to a device for operating a cold start emission control of an internal combustion engine.

### BACKGROUND INFORMATION

In a motor vehicle having an internal combustion engine, increased emission values occur for the most part during a cold start. On the one hand, this is due to the increased untreated emissions of the internal combustion engine during the cold start phase. On the other hand, the emission values are influenced by the poorer efficiency of the catalytic converter during the cold start phase. As long as the operating temperature of the catalytic converter has not yet been reached, the chemical conversion of the harmful combustion agents hydrocarbons, carbon monoxide, and nitrogen oxides into nontoxic substances carbon dioxide, water, and nitrogen is impaired. For this reason, it is important to use a suitable CSERS (cold start emission reduction system) strategy to optimize the emission values of the internal combustion engine during a cold start phase. Thus, the exhaust emissions may, for example, be minimized when the catalytic converter reaches its optimal operating temperature as quickly as possible.

This may be implemented with the aid of motorized measures, additional heaters as well as a suitable placing of the catalytic converter in the proximity of the internal combustion engine. Moreover, it is known to reduce the cold start emissions by retarding the ignition timing and/or by increasing the idling speed. Against this background, it appears to be reasonable to check the functionality or the efficiency of the applied CSERS strategy. Moreover, the CARB (California Air Resources Board) demands a diagnosis of the CSERS strategy. In the known methods, the diagnosis is carried out by hardware-based monitoring of the relevant manipulated variables. Thus, a control period of the injectors is, for example, measured and it is checked whether this period is within a permissible range. If the control period moves outside a range which is tolerable for emissions reasons, the combustion is assessed as erroneous. Furthermore, the ignition angle output, the camshaft positioning, and the high-pressure system of the injection are diagnosed for proper output of the setpoint values during the heating phase of the catalytic converter.

An error signal is output if at the end of the heating phase of the catalytic converter the ratio of erroneous combustions to a total number of combustions during the heating phase of the catalytic converter is greater than a predefined threshold. In this case, the threshold may be set as a function of the emission influence. Thus, manipulated variables are used in the known methods to assess the efficiency or the functionality of the CSERS strategy. If, however, the operation of one component is interfered with (e.g., the injector is coked up), this is not noticed in the known diagnostic methods. This allows the emission values to increase without it being possible to undertake a suitable countermeasure. Moreover, the present diagnosis, in which all actuators (e.g., ignition, injection, camshaft) must be checked individually, is very complex.

### SUMMARY OF THE INVENTION

The exemplary embodiments and/or exemplary methods of the present invention therefore provide a method for operating a cold start emission control of an internal combustion engine, a combustion chamber pressure in at least one cylinder of the internal combustion engine being detected, at least one characteristic variable for a combustion process of the internal combustion engine being determined based on the detected combustion chamber pressure, a setpoint value being established for the characteristic variable, a deviation of the characteristic variable from the setpoint value being determined, and an error entry being generated as a function of the determined deviation.

Furthermore, the exemplary embodiments and/or exemplary methods of the present invention provide a device for operating a cold start emission control of an internal combustion engine, the device being electrically coupled to a combustion chamber pressure sensor and the device being configured to carry out the method of the type mentioned above.

In the exemplary embodiments and/or exemplary methods of the present invention, the signal of a combustion chamber pressure sensor is assessed to be able to evaluate the efficiency of the CSERS measures. According to the exemplary embodiments and/or exemplary methods of the present invention, the physical state is directly assessed in the combustion chamber.

As a result, the proposed method is very reliable. In addition, the present method does not require the diagnoses of the individual actuators to be collected, since the physical effect of the combustion is measured directly via the combustion chamber pressure. Thus, a simple diagnosis of the CSERS strategy may be implemented with the aid of the method according to the present invention.

It particularly may be that the error entry may be generated to evaluate a functionality of the cold start emission control.

If the operation of one component is interfered with, this is still incorporated into the diagnosis of the CSERS strategy, since the physical state in the combustion chamber changes. The interference with the cold start emission control is subsequently documented via the error entry.

In another specific embodiment, the at least one characteristic variable has at least one or multiple variables of pressure/torque values and/or net heat release values.

The pressure/torque values and/or net heat release values are deduced from the detected combustion chamber pressure signal and compared to corresponding predefined setpoint values. These deduced variables allow the instantaneous emission behavior of the internal combustion engine to be reliably detected.

In another specific embodiment, the pressure/torque values have an indicated mean effective pressure, a maximum pressure gradient, a maximum pressure and/or an internal torque of the internal combustion engine.

This allows a precise illustration of the pressure/torque values in the cylinder. On this basis, the functionality of the CSERS strategy may thus be reliably evaluated.

In another specific embodiment, the net heat release values include a combustion start, a combustion end and/or a center of combustion.

By using the combustion start, the combustion end and/or the center of combustion as characteristic variables for the combustion process, the net heat release may be well described. Additionally or alternatively, a 50% mass fraction burn (MFB 50) may also be used for evaluating the emission behavior of the internal combustion engine. This variable characterizes a point in time or a crankshaft angle at which half of the fuel mass is converted. Based on these values, the efficiency of the CSERS strategy may be precisely evaluated.

According to another specific embodiment, the determination of the at least one characteristic variable has the step of digitally filtering an intermediate variable which is determined based on the detected combustion chamber pressure.

With the aid of the digital filtering, interference signals may essentially be filtered out which are present in the combustion chamber pressure signal and are created by closing/opening the inlet valves and exhaust valves.

In another specific embodiment, the intermediate variable is a digital pressure signal or a differential net heat release.

In this way, the interference portions possibly present are reduced, in particular, with regard to their sizes which are used as the basis for the deduced characteristic variables. Finally, this also results in a more reliable evaluation of the CSERS strategy.

According to another specific embodiment of the present method, the generation of the error entry includes the following steps: establishing a threshold value for the deviation; assessing the combustion process as an erroneous combustion process when the deviation exceeds the threshold value; and outputting an error signal when a predefined number of erroneous combustion processes is exceeded.

With the aid of these measures, it is possible to set precisely the point when the error signal is generated by establishing the threshold value and defining the number of erroneous combustions. Here, the error signal indicates that the functionality of the cold start emission control is interfered with.

In another specific embodiment, the generation of the error entry includes the following steps: assessing the deviations with the aid of a factor; adding the assessed deviations to a deviation sum, which detects the assessed deviations over multiple combustion processes and/or the assessed deviations of multiple characteristic variables; and outputting an error signal when the deviation sum exceeds a predefined emission threshold value.

In this specific embodiment, the deviations of a characteristic variable may be added up over the course of the combustion processes. For this purpose, the deviation from the corresponding setpoint value is assessed via an emission function. An error signal is finally output upon exceedance of a predefined emission threshold value. Furthermore, the deviations of multiple characteristic variables may be added up over the course of the combustion processes. Here, it is possible to weigh the deviations of the particular characteristic variables differently. This takes place by using different factors, for example, by which the individual deviations are multiplied. In this way, the CSERS strategy may be assessed even more precisely.

Alternatively, the present specific embodiment, in which the deviation sum is determined, may also be combined with the previous specific embodiment, in which the number of erroneous combustion processes is ascertained. Thus, an error signal is output when either a predefined number of erroneous combustion processes is exceeded or when the deviation sum exceeds a predefined emission threshold value.

According to another specific embodiment, the combustion chamber pressure is detected with the aid of a combustion chamber pressure sensor, the combustion chamber pressure sensor being configured to generate a measuring signal as a function of the combustion chamber pressure.

The combustion chamber pressure sensor may either be configured as a separate component or as an integrated sensor in a spark plug. If the combustion chamber pressure sensor is configured as a separate component, the sensor may be built centrally into a combustion chamber ceiling of the cylinder or laterally.

According to another specific embodiment, the measuring signal is detected at a sampling rate which corresponds to at least 1° KW/combustion cycle.

By using this sampling rate or resolution, the course of the combustion chamber pressure is accurately detected. This allows a good diagnosis of the cold start emission control.

Alternatively, the sampling may also take place in fixed intervals.

In another specific embodiment, the measuring signal is filtered.

If an analog voltage signal is made available by the combustion chamber pressure sensor, anti-aliasing effects may effectively be prevented by using an analog filter. Moreover, interference portions present in the combustion chamber pressure signal may be suppressed.

According to another specific embodiment, the combustion chamber pressure is detected in parallel in all cylinders of the internal combustion engine.

The parallel detection of the combustion chamber pressure in all cylinders allows an even better or more reliable evaluation of the CSERS strategy.

It is understood that the features, properties, and advantages of the method according to the present invention are also accordingly true for or are applicable to the device according to the present invention.

Moreover, the above-mentioned features and the features to be elucidated below are usable not only in the respective stated combination, but also in other combinations or alone without departing from the scope of the present invention.

### BRIEF DESCRIPTION OF THE DRAWINGS

FIG. 1 schematically shows a cylinder of an internal combustion engine having a combustion chamber pressure sensor.

FIG. 2 shows a diagram to illustrate one specific embodiment of a method according to the present invention.

FIG. 3 shows an exemplary course of an emission function.

### DETAILED DESCRIPTION

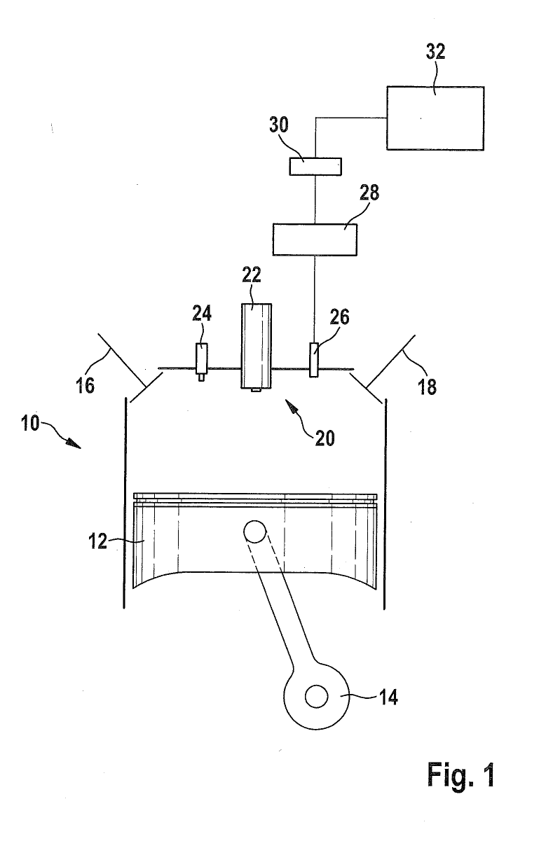

FIG. 1 schematically shows a cylinder 10 of an internal combustion engine. Cylinder 10 has a piston 12 which is mechanically coupled to a crankshaft 14. Furthermore, cylinder 10 has an inlet valve 16 and an exhaust valve 18. In a combustion chamber ceiling 20 of cylinder 10, a spark plug 22, an injector 24, and a combustion chamber pressure sensor 26 are situated. In the present example, combustion chamber pressure sensor 26 is configured as a separate component and is situated in combustion chamber ceiling 20. Alternatively, combustion chamber pressure sensor 26 may also be integrated into spark plug 22. Furthermore, combustion chamber pressure sensor 26 may also be situated laterally at cylinder 10.

Combustion chamber pressure sensor 26 is electrically connected to an analog filter 28 which, in turn, is electrically coupled to an AD converter 30 and a device 32 for operating a cold start emission control.

In the present example, a four-stroke engine is described. However, it is understood that device 32 according to the present invention may also be used in other engines.

In a first stroke of the internal combustion engine, piston 12 is at a top dead center. Exhaust valve 18 is closed and inlet valve 16 is open. In the further course of the first stroke, piston 12 moves toward crankshaft 14. During this downward movement of piston 12, a gas mixture or air is drawn into cylinder 10 through inlet valve 16. As soon as piston 12 reaches a bottom dead center, the first stroke is completed. Inlet valve 16 is closed.

In the course of the second stroke, piston 12 moves back toward the top dead center. The mixture or the air in cylinder 10 is now compressed to a fraction of its original volume. Shortly before reaching the top dead center, an injection is triggered with the aid of injector 24 and an ignition is triggered with the aid of spark plug 22. Alternatively, the injection may also take place during the intake stroke.

During the third stroke, the mixture charge is combusted. Consequently, piston 12 moves toward the bottom dead center. The combustion gas executes mechanical work at piston 12 and cools off in the process. Exhaust valve 18 starts opening.

Upon reaching the bottom dead center, the fourth stroke starts. Here, the exhaust gas is pushed out of cylinder 10 due to the upward movement of piston 12. Exhaust valve 18 closes shortly after piston 12 has reached the top dead center.

With the aid of combustion chamber pressure sensor 26, the combustion chamber pressure within cylinder 10 is detected over the entire combustion cycle of cylinder 10. Combustion chamber pressure sensor 26 makes available a measuring signal or an analog voltage signal which is forwarded to analog filter 28. Anti-aliasing effects are suppressed by analog filter 28. Moreover, interferences in the measuring signal, which are caused by closing and opening inlet valve 16 and exhaust valve 18, for example, may be filtered out. Subsequently, the filtered measuring signal is forwarded to AD converter 30 which digitizes the measuring signal. The combustion chamber pressure is detected at a sampling rate which is indicated in relation to an angle of crankshaft 14. In this case, the resolution of the sampling corresponds to 1° KW/combustion cycle. Alternatively, a higher resolution may also be selected. Moreover, it is possible to also establish the sampling rate over predefined time intervals. Subsequently, the digitized combustion chamber pressure signal is forwarded to device 32 for further processing. Based on the further processed combustion chamber pressure signal, the functionality of the CSERS strategy is finally evaluated. If this diagnosis turns out to be negative, an error signal is output by device 32. The error signal may be used by an on board diagnostic system (not identified in greater detail in FIG. 1) to initiate appropriate countermeasures or to output appropriate alerts on a driver information display.

To sum up, the exemplary embodiments and/or exemplary methods of the present invention assess the signal of combustion chamber pressure sensor 26 to be able to evaluate the efficiency of the CSERS measures. It is not the manipulated variables for the combustion process (for example, ignition angle output, camshaft positioning) which are evaluated, but directly the physical state in the combustion chamber of cylinder 10. This allows a correct diagnosis of the cold start emission control, even if the operation of one or multiple components is interfered with (for example, a coked-up injector). By directly detecting the physical effect of the combustion, it is not necessary to prepare individual diagnoses of the different actuators (ignition, injection, camshaft). In this way, a simple diagnosis of the CSERS strategy may be carried out.

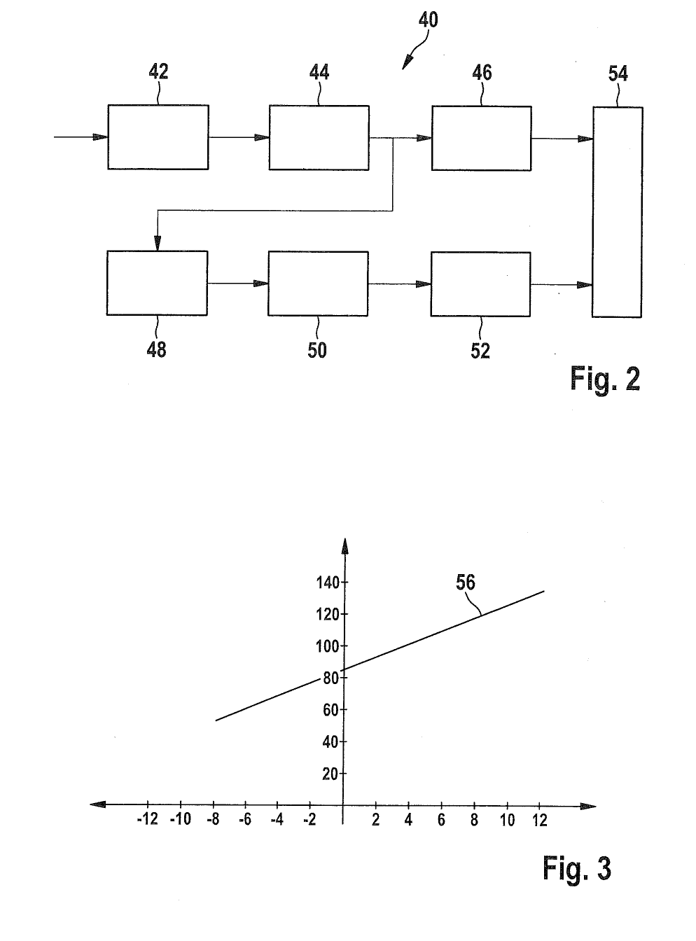

FIG. 2 shows a diagram to illustrate a specific embodiment of a method 40 according to the present invention which may be carried out by device 32, for example.

In method 40 according to the present invention, the combustion chamber pressure is initially detected with the aid of combustion chamber pressure sensor 26 in cylinder 10. The analog measuring signal generated by combustion chamber pressure sensor 26 is supplied to analog filter 28 to avoid anti-aliasing effects and to suppress possible interferences in the analog measuring signal. Subsequently, the analog measuring signal is digitized by AD converter 30. The digitized measuring signal is supplied to a first block 42 for signal detection. Here, the measuring signal or the voltage signal is transformed into a pressure signal based on a sensor characteristic curve of combustion chamber pressure sensor 26.

In a second block 44, an offset correction of the pressure signal (thermodynamic zero-line correction) takes place, since the pressure signal of combustion chamber pressure sensor 26 is subject to a specific offset as a function of the embodiment of combustion chamber pressure sensor 26.

Based on the detected and offset-corrected pressure signal, characteristic combustion properties, pressure/torque values in the present case, are computed in a third block 46. For this purpose, an indicated mean effective pressure, a maximum pressure gradient, a maximum pressure, and an internal torque are deduced from the pressure signal.

These variables are finally used to control or regulate the internal combustion engine.

In a fourth block 48, the differential net heat release in cylinder 10 is moreover computed from the detected and offset-corrected pressure signal. In this case, the differential net heat release represents the released amount of heat per crankshaft angle degree.

With the aid of an integration, a net heat release is determined from the differential net heat release in a fifth block 50.

Based on the determined net heat release, other characteristic combustion properties, net heat release values in the present case, are computed in a sixth block 52. In this case, the net heat release values have the following characteristic variables: center of combustion, combustion start, combustion end, MFB 50. These variables are also used to control or regulate the internal combustion engine.

The characteristic combustion properties ascertained in third block 46 and in sixth block 52 are forwarded to a seventh block 54 for further evaluation. In block 54, a diagnosis of the CSERS strategy is carried out based on the characteristic variables of the combustion. For this purpose, setpoint values are initially established for each characteristic variable.

Subsequently, the deviations of the characteristic variables from their respective setpoint values are determined. Subsequently, the deviations are evaluated with the aid of different factors or different emission functions.

FIG. 3 shows, as an example, a curve of such an emission function 56 for the center of combustion as the characteristic variable. Here, the deviation of the actual center of combustion from the corresponding setpoint value is plotted on the abscissa. The ordinate indicates an assigned emission value. The deviations or emission values assessed via emission function 56 are added to a deviation sum. Here, the deviation sum may have the emission values of an individual characteristic variable over multiple combustion processes. Alternatively, the deviation sum may also include the emission values of multiple characteristic variables over multiple combustion processes. The selection of emission function 56 thus allows the deviations of the different characteristic variables to be weighted with different factors.

As soon as the deviation has exceeded a predefined emission threshold value, an error signal is output. This error signal indicates an error in the CSERS strategy and may be further processed by an on board diagnostic system.

Alternatively or additionally to the above-described method, a threshold value may be defined for the deviation of a characteristic variable and its assigned setpoint value. In this case, a combustion process is assessed as an erroneous combustion process when the deviation exceeds the threshold value. In this specific embodiment, an error signal is output when a predefined number of erroneous combustion processes is exceeded.

With the aid of method 40 according to the present invention, one or multiple characteristic combustion properties are computed from the combustion chamber pressure signal. By comparing these characteristic combustion properties to their assigned setpoint values, it is possible to evaluate the functionality and efficiency of a cold start emission control in a simple and reliable manner. The use of emission functions enables a very flexible weighting of the deviations of the individual characteristic variables.

Although specific embodiments of the method according to the present invention and the device according to the present invention have thus been shown, it is understood that different variations and modifications may be carried out, without departing from the scope of the present invention.

Device 32 may, for example, not only be used in an externally ignited internal combustion engine, but also in an auto-ignited internal combustion engine.

Furthermore, the detection of the combustion chamber pressure signal may take place in parallel in multiple cylinders or in all cylinders of the internal combustion engine.

Moreover, it is possible to additionally filter the digital pressure signal and/or the differential net heat release to essentially eliminate interferences which are present in the signals.

What is claimed is:

1. A method for operating a cold start emission control of an internal combustion engine, the method comprising:
detecting a combustion chamber pressure in at least one cylinder of the internal combustion engine;
determining at least one characteristic variable for a combustion process of the internal combustion engine based on the detected combustion chamber pressure;
establishing a setpoint value for the characteristic variable;
determining a deviation of the characteristic variable from the setpoint value; and
generating an error entry as a function of the determined deviation.

2. The method of claim 1, wherein the error entry is generated to evaluate a functionality of the cold start emission control.

3. The method of claim 1, wherein the at least one characteristic variable has at least one or multiple variables of at least one of pressure/torque values and net heat release values.

4. The method as recited of claim 1, wherein the pressure/torque values have at least one of an indicated mean effective pressure, a maximum pressure gradient, a maximum pressure and an internal torque of the internal combustion engine.

5. The method of claim 1 wherein the net heat release values include at least one of a combustion start, a combustion end and a center of combustion.

6. The method of claim 1, wherein the determining of the at least one characteristic variable includes digitally filtering an intermediate variable which is determined based on the detected combustion chamber pressure.

7. The method of claim 6, wherein the intermediate variable is one of a digital pressure signal and a differential net heat release.

8. The method of claim 1, wherein the generation of the error entry includes the following:
establishing a threshold value for the deviation,
assessing the combustion process as an erroneous combustion process when the deviation exceeds the threshold value, and
outputting an error signal when a predefined number of erroneous combustion processes is exceeded.

9. The method of claim 1, wherein the generation of the error entry includes the following:
assessing the deviation with the aid of a factor,
adding the assessed deviation to a deviation sum which includes at least one of the assessed deviations over multiple combustion processes and the assessed deviations of multiple characteristic variables, and
outputting an error signal when the deviation sum exceeds a predefined emission threshold value.

10. The method of claim 1, wherein the combustion chamber pressure is detected with the aid of a combustion chamber pressure sensor, the combustion chamber pressure sensor being configured to generate a measuring signal as a function of the combustion chamber pressure.

11. The method of claim 10, wherein the measuring signal is detected at a sampling rate which corresponds to at least 1° KW/combustion cycle.

12. The method of claim 10, wherein the measuring signal is filtered.

13. The method of claim 1, wherein the combustion chamber pressure is detected in parallel in all cylinders of the internal combustion engine.

14. A device for operating a cold start emission control of an internal combustion engine, comprising:
an operating device electrically coupled to a combustion chamber pressure sensor, wherein the operating device is configured for performing the following:
detecting a combustion chamber pressure in at least one cylinder of the internal combustion engine;
determining at least one characteristic variable for a combustion process of the internal combustion engine based on the detected combustion chamber pressure;
establishing a setpoint value for the characteristic variable;
determining a deviation of the characteristic variable from the setpoint value; and
generating an error entry as a function of the determined deviation.
